(19) United States
(12) Patent Application Publication
(10) Pub. No.: US 2014/0074647 A1
(43) Pub. Date: Mar. 13, 2014

(54) METHODS AND SYSTEMS FOR RECOMMENDING CLOUD CONFIGURATION IN A CLOUD SERVICE MARKET PLACE

(71) Applicants: Tridib Mukherjee, Bangalore (IN); Gueyoung Jung, Rochester, NY (US)

(72) Inventors: Tridib Mukherjee, Bangalore (IN); Gueyoung Jung, Rochester, NY (US)

(73) Assignee: XEROX CORPORATION, Norwalk, CT (US)

(21) Appl. No.: 13/606,023

(22) Filed: Sep. 7, 2012

(51) Int. Cl. G06Q 30/06

(52) U.S. Cl. 705/26.7

(57) ABSTRACT

In a method and system for providing one or more cloud services in a cloud, one or more high-level parameters are received from a customer through a service requisition interface; a cloud configuration is generated along with a Service Level Agreement (SLA) based on the received high-level parameters; the generated cloud configuration along with the SLA is recommended to the customer through an output interface; the customer is allowed to negotiate the SLA recommendation through the service requisition interface based on a tradeoff between the one or more high level details at a service layer of the cloud through an SLA negotiation system; and the one or more cloud services are provided to the customer based on the negotiated SLA.

### TECHNICAL FIELD

Broadly, the presently disclosed embodiments relate to networks, and more particularly, to methods and systems for providing cloud services.

### BACKGROUND

With the advent of computing clouds, there has been a surge in the cloud-based services business. The concept of cloud-based services is to allow service users to have on-demand access to virtualized resources for service execution: networks, servers, applications, data storage, and services running on a platform. In recent years, there has been a significant increase in the scale of services hosted over the cloud. In addition, the wide gamut of service users ranging from business users, e.g. business analysts, to small and medium business (SMB) customers, make it imperative that the services in the marketplace are presented in an easy-to-use manner. Unfortunately, the state-of-the-art presentation of cloud services requires specific cloud configuration details from users, e.g. SW platform requirements, number of processors, the type and number of virtual machines (VMs), amount of storage etc.

Existing interfaces or virtualization engines e.g. Amazon EC2, Rackspace, Microsoft Azure, ACS AMP 3.0, IBM TSAM, Sun Virtualbox, and so forth present cloud-based services as infrastructure solutions where users need to provide detailed cloud configuration input. Usually, in the SMB marketplace where many cloud vendors such as Xerox and ACS Cloud, intend to extend their cloud services business, the detailed cloud configuration information may be unknown to the users, especially to the non-IT experts. Hence, the users tend to request inefficient configurations of services, either overprovisioning or under-provisioning their services. In the case of overprovisioning, more resources are configured than actually needed; this may lead to resource over-use causing the energy level, and budget for the service to be higher than necessary. On the other hand, in case of under-provisioning, fewer resources may be requested than required to maintain the desired performance demands.

Therefore, there exists a need for methods or systems for recommending cloud configuration and Service Level Agreement (SLA) of applications requested by customers in the cloud service marketplace.

### SUMMARY

An embodiment of the present disclosure provides a method for providing one or more cloud services to customers in a computing cloud. The method includes receiving one or more high-level parameters from a customer through a service requisition interface. The method further includes automatically generating the cloud configuration along with a Service Level Agreement (SLA) based on the received high-level parameters. The method also includes recommending the generated cloud configuration along with the SLA to the customer through an output interface. The method further includes allowing the customer to negotiate terms of the SLA through the service requisition interface based on tradeoff regarding the one or more high-level parameters at a service layer of the cloud through an SLA negotiation system. Furthermore, the method includes providing the one or more cloud services based on the negotiated SLA to the customer.

Another embodiment of the present disclosure provides a method for providing cloud based services to a customer in a computing cloud. The method includes receiving one or more high-level parameters from the customer through a service requisition interface. The high-level parameters include at least one of a performance level, Green Point, budget, and location. The method also includes automatically generating a cloud configuration along with a Service Level Agreement (SLA) based on the received high-level parameters. The cloud configuration along with the SLA is generated by using a constraint optimization method based on a best-first graph search method. The method also includes recommending the generated cloud configuration along with the SLA to the customer through an output interface. The method further includes allowing the customer to negotiate the SLA recommendation through a service requisition interface based on a tradeoff between the one or more high-level parameters at a service layer of the cloud. The method further includes allowing the customer to negotiate the SLA through the service requisition interface based on a tradeoff regarding the one or more high level details at a service layer of the cloud, wherein allowing the customer to negotiate the SLA further comprises performing the steps of receiving, generating and recommending until the customer is satisfied with the SLA. The method further includes providing the one or more cloud services based on the negotiated SLA to the customer.

Yet another embodiment of the present disclosure provides a system for providing one or more cloud services to a number of customers in a cloud. The system includes a cloud configuration system at a service layer of the cloud. The cloud configuration system includes a service requisition interface for receiving one or more high-level parameters from a customer. The service requisition interface includes one or more high-level parameter fields. The cloud configuration system also includes a cloud configuration generator for automatically generating the cloud configuration along with a Service Level Agreement (SLA) based on the received high-level parameters. The cloud configuration system also includes an output interface for recommending the generated cloud configuration along with the SLA to the customer. Further, the cloud configuration system includes an SLA negotiation system for allowing the customer to negotiate the SLA through the service requisition interface based on tradeoffs regarding the one or more high level details at a service layer of the cloud. The cloud provides the one or more cloud services based on the negotiated SLA to the customer.

### BRIEF DESCRIPTION OF THE DRAWINGS

FIG. 1 illustrates exemplary cloud architecture, in accordance with various embodiments of the present disclosure.

FIG. 2 shows a sample snapshot of a typical service request interface in a conventional environment.

FIG. 3 illustrates exemplary components of the cloud configuration system, in accordance with an embodiment of the present disclosure.

FIG. 4 illustrates a snapshot of the exemplary service requisition interface for requesting cloud-based services, in accordance with an embodiment of the present disclosure.

FIG. 5 illustrates an exemplary snapshot of the output interface for presenting sample cloud configuration and an SLA recommendation to the customer(s), in accordance with an embodiment of the present disclosure.

FIG. 6 illustrates an exemplary system architecture for generating recommendations automatically, in accordance with an embodiment of the present disclosure.

FIG. 7 illustrates an exemplary search in the form of a graph when a performance level preference for requested service application is provided by the customer(s), in accordance with an embodiment of the present disclosure.

FIGS. 8A-8B is a flowchart illustrating a method of generating a cloud configuration or SLA agreement when a performance level is provided by a customer, in accordance with an embodiment of the present disclosure.

FIGS. 9A-9B is a flowchart illustrating a method of generating a cloud configuration or SLA agreement when a Green Point value is provided by a customer, in accordance with an embodiment of the present disclosure.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### DEFINITIONS

In various embodiments, definitions of one or more terms that will be used in the document are described below. The term “energy rating” defines the relative energy consumption by a cloud-based service with respect to all other services in a cloud. The term ‘green operation’ indicates the effect of the carbon footprint on the environment. The energy rating is therefore inversely related to the green operation—the lower the energy consumption, the greener the operation. Quality of Service (QoS) includes various factors, for example, response time and throughput for delivering the cloud services successfully. Service Level Agreement (SLA) is a contract with QoS guarantees as required by the cloud customer.

### Overview

The present disclosure provides methods and systems for providing one or more cloud services to a number of customers in a cloud. For each customer, the method includes receiving one or more high-level parameters from the customer through a service requisition interface; automatically generating the cloud configuration along with a Service Level Agreement (SLA) based on the received high-level parameters; recommending the generated cloud configuration along with the SLA to the customer through an output interface; allowing the customer to negotiate the SLA recommendation through the service requisition interface based on tradeoffs between the one or more high level details at a service layer of the cloud through an SLA negotiation system; and providing the one or more cloud services based on the negotiated SLA to the customer.

### Overall Exemplary Cloud Architecture

Energy consumption to run cloud-based services is derived mainly from the underlying infrastructure but there are different components contributing to the energy demand of the overall cloud. As discussed above, those components are platform-specific energy demand, and service-specific energy demand. Unlike the infrastructure-specific demand and the platform-specific demand, the service-specific energy demand, however, can be relaxed by allowing negotiations of SLAs on Quality of Service (QoS) parameters. Thus, service-specific energy reduction can provide higher flexibility by enabling reduction in performance (i.e., by relaxing the QoS parameters) and hence providing greater opportunity for energy savings. The present disclosure intends to address the gap by focusing on the service layer.

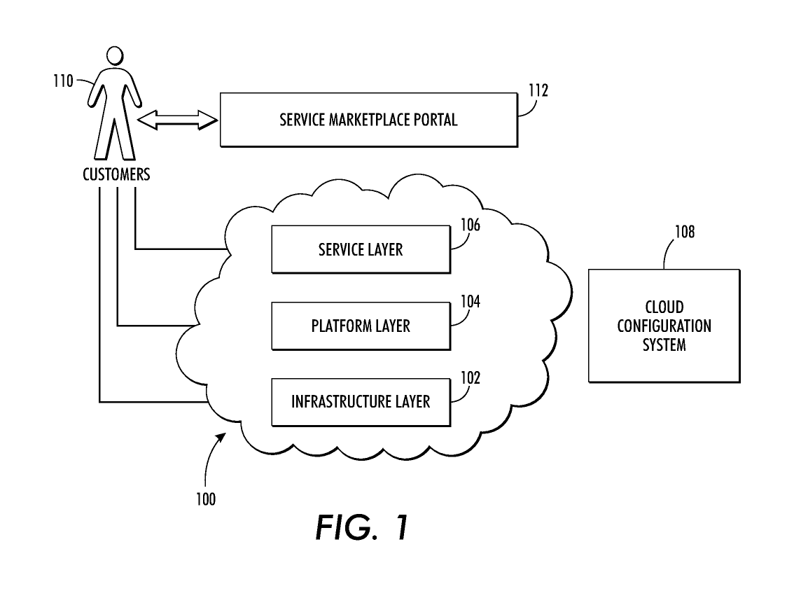

FIG. 1 illustrates an exemplary cloud architecture 100 (or cloud 100), in accordance with an embodiment of the present disclosure. The cloud 100 may be a cloud service market place. To analyze the present disclosure, the cloud includes an infrastructure layer 102, a platform layer 104, also known as middleware/virtualization layer, a service layer 106, a cloud configuration system 108, one or more customer(s) 110, and a service marketplace portal 112. Each of the shown components communicates with the others via conventional network protocols and will be described in detail in the following sections.

The Infrastructure layer 102 includes various kinds of computing equipment such as servers, switches, databases, and the like. The various kinds of computing equipment are required to support operations and host the services. In some embodiments, a service monitoring & management system, and a provisioning & management system (not shown) are implemented at the infrastructure layer 102. These systems determine power profiles of the equipment at the underlying infrastructure layer when required. The platform layer 104 offers platforms in terms of operating systems, Windows Azure, for example, which runs over the underlying infrastructure. In some implementations, at the platform layer 104, virtual machines are hosted on the actual machines or servers. Finally, at the service layer 106 various services are hosted that are used by the customer(s) 110.

The cloud-based services are traditionally presented to the customer(s) 110 in a way where the customers are required to input specific cloud configuration details such as, hardware (HW), software (SW), platform, and resource requirement. Such information is usually unknown to business users especially in an SMB marketplace. Hence, services are either over-provisioned leading to energy overhead or under-provisioned affecting performance. The present disclosure provides the cloud configuration system 108 that relieves the customer from the overhead of entering all the configuration details for requesting various cloud-based services. The cloud configuration system 108 is configured to estimate and recommend a cloud configuration and a corresponding service level agreement (SLA) to the customer(s) 110 based on few high level details such as, performance level, location, Green Point, budget, and so forth, received from the customer(s) 110. Through the service marketplace portal 112, various service offerings can be provided to the one or more customer(s) 110.

The cloud configuration system 108 uses energy rating for cloud-based software services. To compute the energy rating, a rating engine takes into account service configuration and energy profile of the underlying infrastructure. In one embodiment, the service configuration and energy profile are input by the service monitoring & management system.

In one embodiment, the cloud configuration system 108 computes the energy rating based on various computation configuration parameters and communication configuration parameters. The computation configuration parameters may include (a) the types of server requested (i.e. computation demand): the demand for high power servers increases energy consumption, and (b) the number of servers requested (known as resource demand): the larger the number of servers requested, the higher the energy consumption.

The communication configuration parameters include (a) the bandwidth requested (i.e. communication speed demand): high communication bandwidth increases energy consumption, and (b) the input data size (i.e., load on communication): a large amount of input data can increase communication energy consumption.

Finally, the performance demand configuration parameters include time to complete the service (i.e. service duration). Increased execution time increases the energy consumption. Each of these parameters has different levels of impact on the energy consumption. For example, if a majority of the underlying structure has dual core processors and RAM equal to 2 GB, then two servers will be required for a service requiring 4 GB RAM, but if the majority of the servers in the underlying infrastructure have quad core processors, and RAM equal to 4 GB, then only a single server is required for that service. The configuration parameters as defined above may be derived from the service requirement. For example, the types and numbers of servers may not be directly provided by the user.

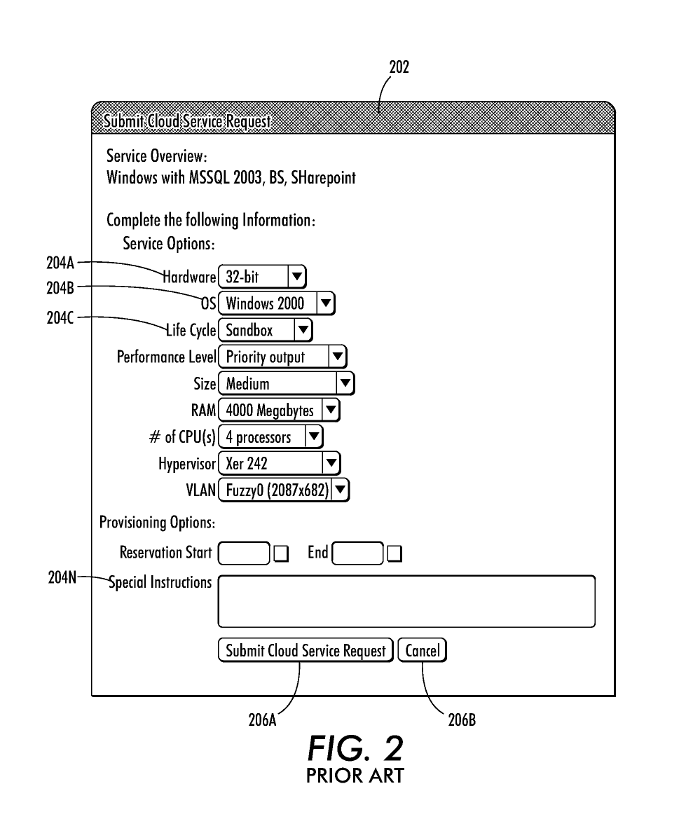

FIG. 2 shows a sample snapshot of a typical service request interface 202 in a conventional environment. The interface 202 is representative of the current state-of-the-art in how services need to be configured by the users. It is evident from the interface 202 that specific details relating to hardware, operating system, RAM, number of central processing units (CPUs), virtualization middleware (e.g. Hypervisor) etc., needed for the service's delivery are required from users. However, such details are typically unknown to users. Hence, users tend to request inefficient configurations of services, either over-provisioning or under-provisioning their services. In case of over-provisioning, more resources may be configured than actually needed. This may lead to resource over-use causing the energy level as well as budget for the service to be higher than necessary. On the other hand, in the case of under-provisioning, less resource may be requested than required to maintain the performance demands.

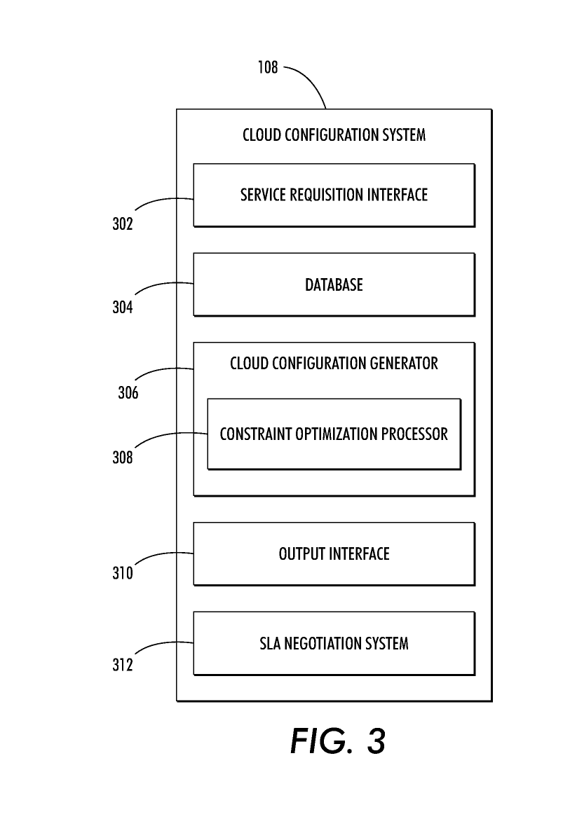

The present disclosure provides a solution to the existing problems by disclosing the cloud configuration system 108 which can automatically recommend a cloud configuration and SLA to the customer(s) 110 based on one or more high level configuration details received from the customer(s) 110. The cloud configuration system 108 enables the customer(s) 110 to provide their requirements in terms of high-level configuration parameters such as, but are not limited to, performance level, energy level, location, budget, and so forth, at which they want the service(s) to be delivered. The disclosed cloud configuration system 108 may then build a detailed configuration automatically without burdening the users to input specific configuration details. The components of the cloud configuration system 108 are explained in detail with respect to FIG. 3.

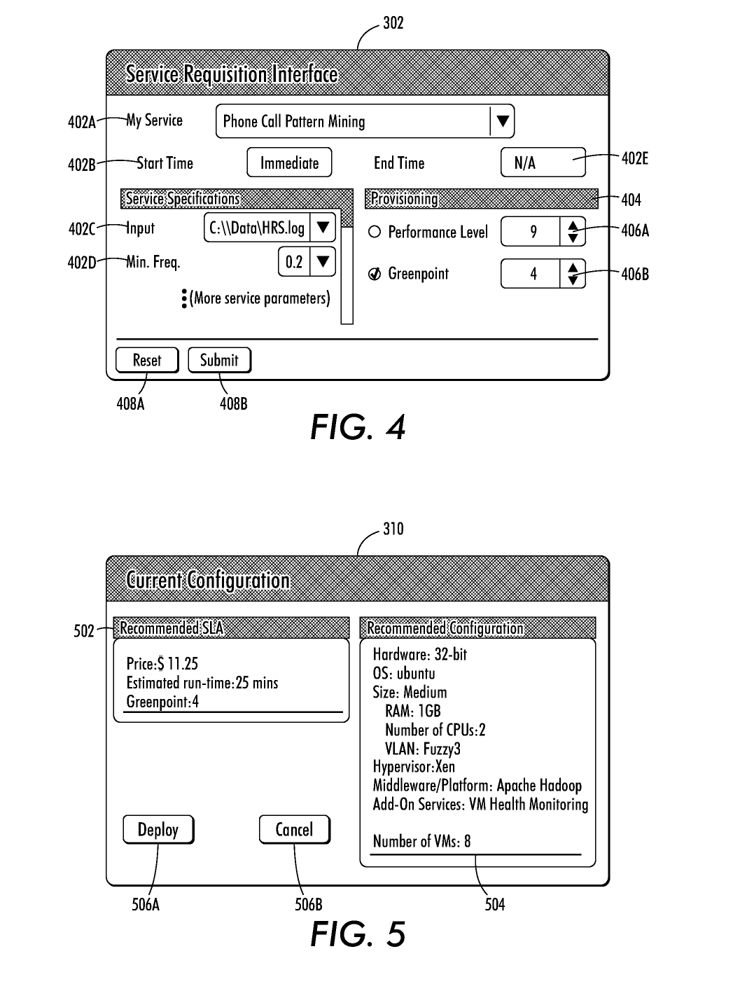

FIG. 3 illustrates exemplary components of the cloud configuration system 108, in accordance with an embodiment of the present disclosure. The cloud configuration system 108 includes a service requisition interface 302 including one or more fields and buttons or tabs. The service requisition interface 302 is configured to receive one or more high-level parameters from the customer(s) 110. The service requisition interface 302 includes one or more high-level parameter fields. The service requisition interface 302 enables the one or more customer(s) 110 to input or choose one or more high-level configuration parameters such as performance level. The customer(s) 110 can interact with the service requisition interface 302 and enter one or more high-level parameter in the fields of the service requisition interface. The customer(s) 110 can choose an available service from various services stored in a database 304. The database 304 may also store information about various resources such as, but are not limited to, servers, computers, hypervisors, network devices, and so forth present in the cloud 100. The service requisition interface 302 is also configured to receive one or more service inputs from the customer, wherein the service inputs may include at least one of a service name and one or more service specific parameters. Examples of the service specific parameters may include, but are not limited to, start time, end time, frequency, and so forth. The service requisition interface 302 is further explained in detail with respect to FIG. 4.

The cloud configuration system 108 further includes a cloud configuration generator 306 for automatically generating the cloud configuration along with a Service Level Agreement (SLA) recommendation based on the received high-level parameters. The cloud configuration generator 306 generates the cloud configuration along with the SLA recommendation based on a demand of the customer(s) 110 for service delivery, availability and dependency of hardware and software in the cloud 100. In one embodiment, the cloud configuration along with the SLA may be generated by using a constraint optimization method based on a best-first graph search method. In another embodiment, the best-first graph search method is an A* search algorithm. The A* search algorithm is a computer implemented algorithm which is widely used to plot an efficiently traversal path between nodes. The A* search algorithm finds a least-cost path from a given initial node to one target node out of multiple nodes. As A* search algorithm traverses the graph including multiple nodes, it follows a path of the lowest known heuristic cost (or other high-level parameter), keeping a sorted priority queue of alternate path segments along the way. Further, the constraint optimization method may use the service parameters as constraints on hardware and software availability and dependency along with the high-level parameters to plan the cloud configuration.

The cloud configuration generator 306 further includes a constraint optimization processor 308 for searching one or more resources to meet preferences of the customer(s) 110 while considering software (SW) and hardware (HW) availabilities and their dependencies. For example, when the constraint optimization processor 308 may search in “Dallas” data center, and the data center has only a certain number of Intel Servers, then the constraint optimization processor 308 may define Server dependency in “Dallas” data center is “Intel Server”. Additionally, when those Intel Servers can only run Ubuntu operating system, then the constraint optimization processor 308 may define the operating system dependency of those Intel Servers as being “Ubuntu”. The constraint optimization processor 308 may thus find an estimated best configuration for the preference of the customer(s) 110 based on the extra constraints i.e. availability and dependency.

As shown in FIG. 3, the constraint optimization processor 308 may take three inputs: a) the configuration parameters or variables and their possible value spaces; b) the rule sets that impose various constraints on these variables; and c) estimations (and quantification models) of energy consumption and performance of cloud infrastructure. The configuration variables and value space is the set of discrete variables that can impact the cloud configuration to be built for a service application. This may include three types of variables: a) customization parameters that can be input by users such as Green Point or performance level demanded for the service; b) system specific parameters such as virtual machine (VM) types, hypervisors, and middleware platforms offered by current cloud providers; and c) infrastructure specific parameters such as location and available hardware resources used in each location, etc. as offered by the current cloud providers. The hypervisor may be a virtual machine manager that allows multiple operating systems to use a single host computer. The input may also include the value space i.e. the various values that these variables can take. Therefore, the customer(s) 110 is not required to learn values for these variables and may choose the values from the value space. An example of value space for each of the variables is given below:

Green Point = {1, 2, 3, 4, 5}
PerformanceLevel = {1, 2, 3, 4, 5, 6, 7, 8, 9, 10}
Location = {Dallas, Pittsburgh, KaulaLumpur, Blythewood, LasVegas,
Telford, SouthAmerica, Amberglen}
HWType = {DellServer_16-cores-64 GB, IBMBlade_128-cores-128 GB,
IntelServer_8-cores-32 GB, Greenplum appliance, SimpleCloud}
Number of Servers = {1~100}
HostOS + {Ubuntu, centOs, Redhat, windowsServer, windows7}
HyperVisor = {Xen, VMWare EXS, KVM}
VMType = {lowest, low_end, mid_end, high_end, highest}
OR
{GuestOS= {Ubuntu, centOS, Redhat, windowsServer, windows7}
CPU = {2_cores_2.5, 2_crores_3.0, 4_cores_2.2, 8_cores_2.2}
Memory = {1 GB, 2 GB, 4 GB, 8 GB, 16 GB, 32 GB}
Storage = {500 GB, 1TB, 2TB, 4TB}}
Number of VMs = {1~100}
Platforms = {Hadoop, MySQL, DB2, Greenplum}

The customer(s) 110 may select the high-level parameters from a value set associated with the one or more high-level parameter fields of the service requisition interface 302. Further, based on the variables and their respective value sets, there are certain rule sets that may impose constraints on what value the variables feasibly can have in a cloud configuration to be built. For the variables representing the customization parameters such as Green Point, Location etc., the rule sets may represent the preferences of the customer(s) 110 on these parameters. For the variables pertaining to the system and infrastructure specific parameters, the rule sets represent the dependencies of HW on specific location, host OS and hypervisors on specific HW and SW on middleware and platforms. For the rule sets representing dependencies, the cloud configuration system 108 may use a notation convention A=>B, where B is the dependent variable and A is the variable on which the dependent variable depends. The notation denotes the dependency relationship as “A implies B”. Apart from these, there are rule sets that may capture the availability of resources. For example, the number of VMs is dependent on the number of HW resources available and the types of VMs. The rule sets for different types of variables is described in detail below.

The “customer preferences” may include required preferences such as Green Point or performance level as well as optional preferences such as any HW and SW preference and any location preference. As there can be a tradeoff between energy level and performance level, it may be useful for the customer(s) 110 to choose either the performance level or Green Point as their preferences. For example, the customer(s) 110 may choose a Green Point value “4” and location as “Dallas”.

The “HW dependencies” may include any dependency between hardware and location. The general form of the dependency is HWDependence (location): [location [symbol] Location] [symbol] [hw [symbol] HW], where ‘location’ is a specific value in the value space of variable ‘Location’, and ‘hw’ is the subset of value space of variable ‘HW’, i.e. for each location there is some subset of hardware hosted in that location. For example, if at the Dallas data center only IntelServer_{—}8-cores-32 GB and DellServer_{—}16-cores-64 GB servers are deployed, then the rule set of HW dependency can be: HWDependence(Dallas): [Dallas] [symbol] [{IntelServer_{—}8-cores-32 GB(1˜3), DellServer_{—}16-cores-64 GB(1˜7)}], where the number in parenthesis may represent the number of available servers in the data center.

The “Host OS and Hypervisor dependencies” may include dependencies of Host OS and Hypervisor on the server. In an embodiment of the present disclosure, these dependencies can be denoted generally as [hw [symbol] HW] [symbol] [hOS [symbol] HostOS] and [hw [symbol] HW] [symbol] [hv [symbol] Hypervisor], following similar conventions as mentioned in “HW Dependency” above. For example, if CentOS, Ubuntu, and WindowServer are the host OS and KVM & Xen are the hypervisors deployed on IntelServer_{—}8-crores-32 GB servers then the corresponding dependencies can be given by the following rule sets, [Intel_Server_{—}8-cores-32 GB] [symbol] [{CentOS, Ubuntu, WindowsServer}], and [IntelServer_{—}8-cores-32 GB] [symbol] [{KVM. Xen}].

The “SW dependencies” (or Software dependencies) may capture the situation where certain middleware or platform is deployed on a Host OS and the rule set is generally represented as [hOS [symbol] HostOS] [symbol] [sw [symbol] Middlewares/Platforms]. For example, if Hadoop is deployed and is derived from the availability of processors and memory in servers as follows,

[vms [symbol] Number of VMs]=min ((No. of processors available in server)/(No. of processors in a VM))/((Amount of memory available in server)/(Amount of memory in a VM)).

For example, if 3 IntelServer_{—}8-cores-32 GB servers, i.e. 24 cores and 96 GB RAM, are available in Dallas data center then the number of low-end (2 cores, 1 GB RAM), mid-end (2 cores, 4 GB RAM), high-end (4 cores, 16 GB RAM), and highest (4 cores, 16 GB RAM) virtual machines (or VMs) that can be hosted on the available resources are 12, 12, 6, and 3 respectively calculated by using the above equation.

The cloud configuration generator 306 is configured to estimate and generate cloud configuration based on the one or more high-level details and inputs received from the customer(s) 110 via the service requisition interface 302. In one embodiment, the cloud configuration generator 306 may generate the cloud configuration based on at least one of, but not limited to, the performance level, Green Point, budget, and location. The cloud configuration generator 306 is configured to estimate at least one of, a budget, a Green Point, a performance level, and energy consumption for each possible cloud configuration based on the received high-level parameters.

The cloud configuration generator 306 is also configured to estimate and recommend SLAs to the customer(s) 110 based on the inputs received from the customer(s) 110 via the service requisition interface 302. In one embodiment, the cloud configuration generator 306 may estimate budget, performance, and Green Point along with the recommended cloud configuration based on the given customer preference or inputs and resource availability. The Green Point may define the energy consumption for a particular cloud service.

The cloud configuration generator 306 may estimate the energy consumption and performance for each possible configuration using various conventional quantification models. In one embodiment, the cloud configuration generator 306 may use a linear energy consumption model that shows energy consumption linearly increasing as resource usage increases for a given service application. In one embodiment, the cloud configuration generator 306 may estimate performance using a queuing model, which relies on available resources. The cloud configuration generator 306 can convert estimated energy consumption and performance into Green Point and performance level based on the quantification models and available resources reported by monitoring sub-systems. The cloud configuration generator 306 is also configured to determine the Green Point value by capturing the relative energy consumption of the given service application with respect to all the other services and then applying discretization on the relative energy consumption. The discretized ranges of values are referred to as Green Point values. The cloud configuration generator 306 is also configured to compute performance levels by first computing the fraction of available resources with respect to the total resources and computing similar fractions on the performance of available resources. These two fractions are then multiplied to compute a composite fraction on the performance characteristics of the service. The fraction is discretized in ten distinct ranges, i.e. performance level of 1 represents 0 to 0.1, whereas performance level 10 represents 0.9 to 1 of the composite fraction.

As an example, if a service will use 1000 highest-end VMs out of a total of 1000 VMs and if a highest-end VM's execution time is 95% with respect to all other types of VMs, then the composite fraction for the service can be obtained as (1000/1000)*0.95=0.95, which falls in the range of 0.9 to 1 and hence the performance level is 10. Similarly, if the service uses 1 low-end VM out of 1000 VMs and if the low-end VM has an execution time of 1% with respect to all other types of VMs, then the performance level becomes 1.

Further, the cloud configuration generator 306 may calculate the SLA for a given service application by estimating energy consumption and performance for each possible cloud configuration using quantification models. Many quantification models are currently used in research prototypes and commercial products. The cloud configuration generator 306 may calculate the SLA by using any conventional quantification model and is not dependent on any specific model. The cloud configuration generator 306 may use a linear energy consumption model that shows that the energy consumption increases linearly when resource usage is increased for a given application. In one embodiment, the cloud configuration generator 306 may use a queuing model for estimating performance, which also relies on available resources as used in the same domain. Such queuing model may be developed in the experimental environment. In another embodiment, the cloud configuration generator 306 may obtain estimates for different servers and virtual machines from existing benchmark profiles. Further, the cloud systems or modern data centers may monitor currently available resources at runtime.

The cloud configuration system 108 also includes an output interface 310 to present recommended cloud configurations and recommended SLAs. The output interface 310 may also include a number of sections and buttons as described in detail with respect to FIG. 5. In one embodiment, the cloud configuration system 108 includes a web-based interface to present the recommended cloud configuration and recommended SLA to the customer(s) 110.

The customer(s) 110 may either deploy or cancel the SLA recommendation by selecting one or more buttons of the output interface 310. The cloud configuration system 108 further includes an SLA negotiation system 312, which allows the customer(s) 110 to negotiate the SLA recommendation through the service requisition interface 302 based on tradeoff between the one or more high level details at a service layer of the cloud 100. The customer(s) 110 when not satisfied with the recommended SLA may cancel it and negotiate the SLA by changing or entering one or more high-level details entered via the service requisition interface 302. The cloud configuration generator 306 may then re-generate the cloud configuration based on the modified high-level parameters. Thereafter, the output interface 310 may present the new cloud configuration and new SLA to the customer(s) 110. In case a customer 110 is not satisfied with the SLA, the customer may again cancel it and re submit the high-level details. The SLA negotiation system 312 is further configured to change the SLA recommendation based on the service level negotiation. This process is repeated until the customer 110 is satisfied with the generated SLA recommendation and/or cloud configuration.

FIG. 4 illustrates a snapshot of the exemplary service requisition interface 302 for requesting cloud-based services, in accordance with an embodiment of the present disclosure. The service requisition interface 302 includes a number of data fields 402A-402E, where the customer(s) 110 can choose a value from associated drop down menu having a value set for each of the data fields 402A-402E or may input the value. Examples of the data fields 402A-402E may include, but are not limited to, ‘My Service field’, ‘Start Time’, ‘End Time’, ‘Input’, ‘Minimum frequency’, and so forth. The service requisition interface 302 is further configured to receive one or more service inputs from the customer(s) 110 through these data fields 402A-402E. The service inputs include at least one of a service name and one or more service specific parameters.

As show, the service requisition interface 302 may also include a provisioning section 404 including one or more high-level parameter fields 406A-406B. The customer(s) 110 may select or enter a value through the drop down menu of these high-level parameter fields 406A-406B. In another embodiment, the value can be chosen through slide bars. Examples of the high-level parameter fields 406A-406B include, but are not limited to, a performance level field, a Green Point field, a budget field, and so forth. The Green Point field may allow a user to choose or enter a value of Green Point metric such as, but not limited to, 2, 3, 4, etc. The Green Point metric may define the energy rating or consumption of energy required for a particular cloud services. For example, the customer(s) 110 may request cloud services for which the Green Point value is 4.

The service requisition interface 302 removes the requirement to input cloud configuration details. The customer can choose an available service from a service repository in the My Service field 402A. The service requisition interface 302 may also ask for specific service parameters that depend on the requested service. The customer(s) 110 may choose values in one or more high-level parameter fields 406A-406B. In one embodiment, the customer(s) 110 may choose either a performance level or the Green Point value. The disclosed system may generate a cloud configuration recommendation based on the input received from the customer(s) 110 in the high-level parameter fields 406A-406B. For example, if a customer 110 chooses Green Point with a value 4. The disclosed system considers “Green Point=4” as a constraint and attempts to maximize performance level under this constraint.

FIG. 5 illustrates an exemplary snapshot of the output interface 310 for presenting sample cloud configuration 502 and an SLA recommendation 504 to the customer(s) 110, in accordance with an embodiment of the present disclosure. The output interface 310 is an interactive interface and the customer(s) 110 may interact with the output interface 310. As discussed with reference to FIGS. 3 and 4, the cloud configuration generator 306 may estimate budget, performance (e.g., service execution time), and Green Point based on the high level parameters provided by the customer(s) 110 in the high-level parameter fields 406A-406B. The cloud configuration generator 306 may estimate and generate a cloud configuration based on the high-level parameters provided by a customer 110 in the high-level parameter fields 406A-406B. In one embodiment of the present disclosure, when a customer 110 is not satisfied with the recommended SLA 504 or the recommended cloud configuration 502, the SLA negotiation system 312 allows the customer 110 to tune his/her preference and re-submit the requirement. The customer 110 may either deploy or cancel the recommended cloud configuration 502 or the recommended SLA 504 by selecting a deploy button 506A or a cancel button 506B, respectively. In one embodiment, when the customer 110 selects the cancel button 506B, the service requisition interface 302 is be presented to the customer 110 so that the customer 110 can modify his/her preferences and enter one or more parameters.

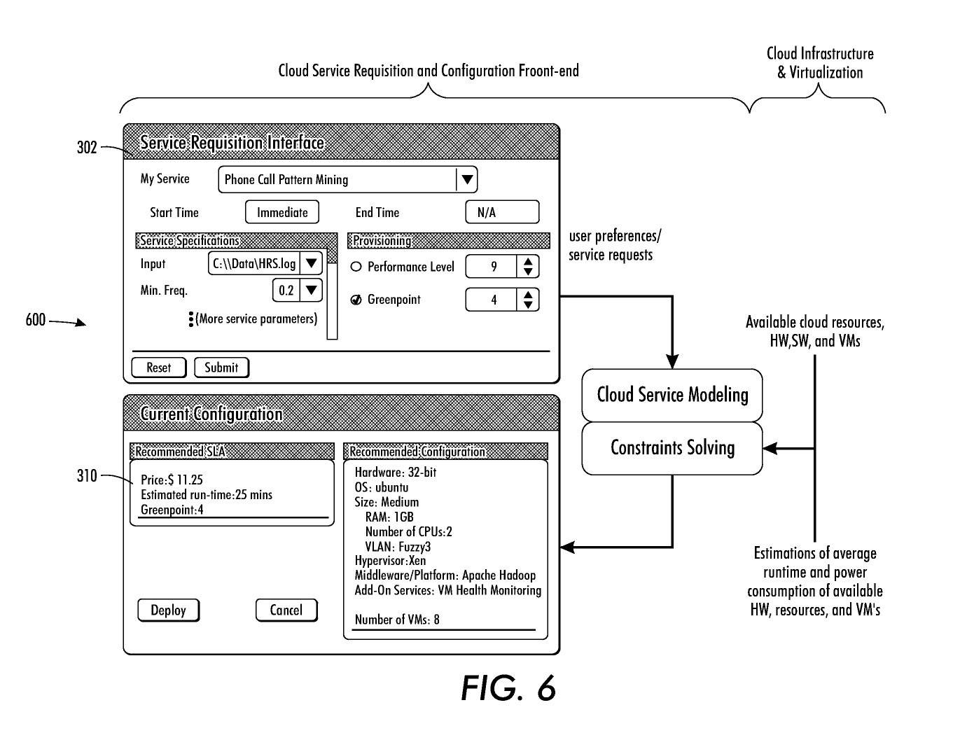

FIG. 6 illustrates an exemplary system architecture 600 for generating an SLA recommendation automatically, in accordance with an embodiment of the present disclosure. As discussed with reference to FIGS. 3, 4 and 5, the cloud configuration generator 306 may estimate the SLA and cloud configuration based on the high-level parameters, such as the performance level, Green Point, and so forth, received from the customer 110 via the service requisition interface 302. The cloud configuration system 108 may also present these recommendations to the customer 110 using the output interface 310. The constraint optimization processor 308 may search resources to meet the inputs or preferences received from the customer 110 while considering software and hardware availabilities and their dependencies. For example, when the constraint optimization processor 308 searches in the “Dallas” data center, and the data center has only a certain number of Intel Servers, then the constraint optimization processor 308 may define Server dependency in the “Dallas” data center as “Intel Server”. Additionally, when those Intel Servers can only run the Ubuntu operating system, the constraint optimization processor 308 may define the operating system dependency of those Intel Servers as “Ubuntu”. The constraint optimization processor 308 may then find an estimated best configuration for the preference of the customer 110 based on the extra constraints i.e. availability and dependency. Further, if the customer 110 is not satisfied with the recommended SLA he/she may negotiate it by canceling the recommended SLA.

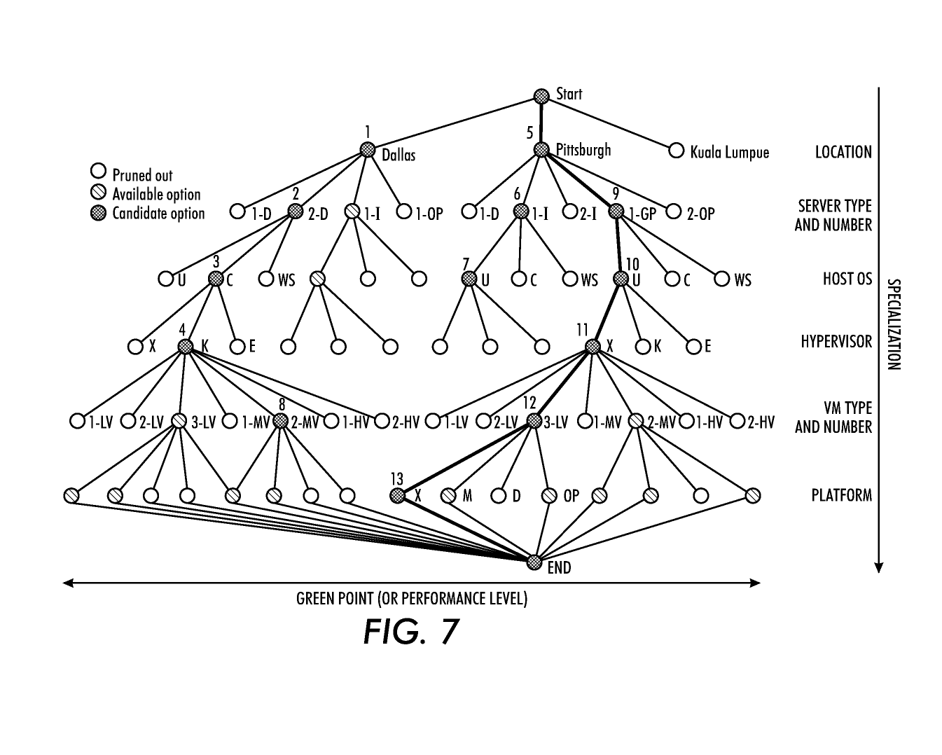

FIG. 7 illustrates an exemplary search in the form of a graph when a performance level preference for requested service application is provided by the customer 110, in accordance with an embodiment of the present disclosure. As discussed with reference to FIG. 3, the constraint optimization processor 308 searches resources to meet preferences of the customer 110 while considering the SW and HW availabilities and their dependencies. In one embodiment, the constraint optimization processor 308 may adopt an A* graph search algorithm with admissible heuristic Green Point and performance level to estimate the cloud configuration and/or SLA recommendation. The search may start from ‘location’ parameter and then go deep (i.e., more specialized) based on dependency rule set, i.e. first it decides the best ‘Location’ and then best ‘Server’ in the location and so on.

When the performance level preference is provided by the customer 110, the search aims to maximize the Green Point, i.e., minimize energy consumption, while meeting the given performance level. At the start point i.e., ‘Start’ in the FIG. 7, the constraint optimization processor 308 generates all possible locations for example, ‘Dallas’, ‘Pittsburgh’, and ‘Kuala Lumpur’. The constraint optimization processor 308 may then apply a dependency rule set for example, ‘performance level=8’. In this FIG. 7, the constraint optimization processor 308 prunes out ‘Kuala Lumpur’ because the location cannot meet ‘performance level=8’ even though the cloud configuration system 108 utilizes all currently available resources in the location. The constraint optimization processor 308 records the possible options such as, ‘Dallas’ and ‘Pittsburgh’ in a queue. The constraint optimization processor 308 then determines which location has the maximal Green Point by sorting the options with admissible heuristic Green Point values. Each admissible heuristic Green Point value indicates the approximated best Green Point at the ‘current node’ or ‘current location’. In one embodiment, the admissible heuristic Green Point value may indicate the approximated shortest path from the ‘current node’ to an ‘End node’. In FIG. 7, the constraint optimization processor 308 may choose ‘Dallas’ as the next starting point for the search because its admissible heuristic Green Point value is the current best. Then, the constraint optimization processor 308 may generate all possible Server Types and the number of each Server Type in the location. Based on the dependency rule set, ‘1-GP’ meaning ‘1 Greenplum appliance’ is not available in the location, so that it is pruned out. ‘1-D’ meaning ‘1 Dell server’ cannot meet ‘performance level=8’, therefore it is also pruned out. The constraint optimization processor 308 then stores ‘2-D’ and ‘1-I’ into the queue that currently has ‘Pittsburgh’ node. It sorts the queue with the admissible heuristic Green Point values and then chooses ‘2-D’ as the next starting point for the search. At the previous search, the admissible heuristic Green Point value of ‘Dallas’ was considered when it used ‘1-D’, which is the highest possible Green Point in ‘Dallas’. Although in accordance with the disclosed algorithm, the constraint optimization processor 308 chooses ‘2-D’ instead of ‘1-D’ in ‘Dallas’, it turns out that ‘2-D’ in ‘Dallas’ still has a higher Green Point than ‘Pittsburgh’. When the search reaches ‘Hypervisor level’ in ‘Dallas’ i.e. number 4 in the FIG. 7, it turns out the ‘Pittsburgh’ is possibly better than the current option. Thus, the disclosed algorithm starts from ‘Pittsburgh’. The search is over once it reaches ‘End’ because the current path is possibly better than the best efforts in other options by the definition ‘admissible heuristic Green Point’. Finally, it returns the path as a specialized configuration and budget based on resources to be used in the configuration for the service application.

In one embodiment, when the Green Point preference is provided by the customer 110 the constraint optimization processor 308 may try to maximize the performance level.

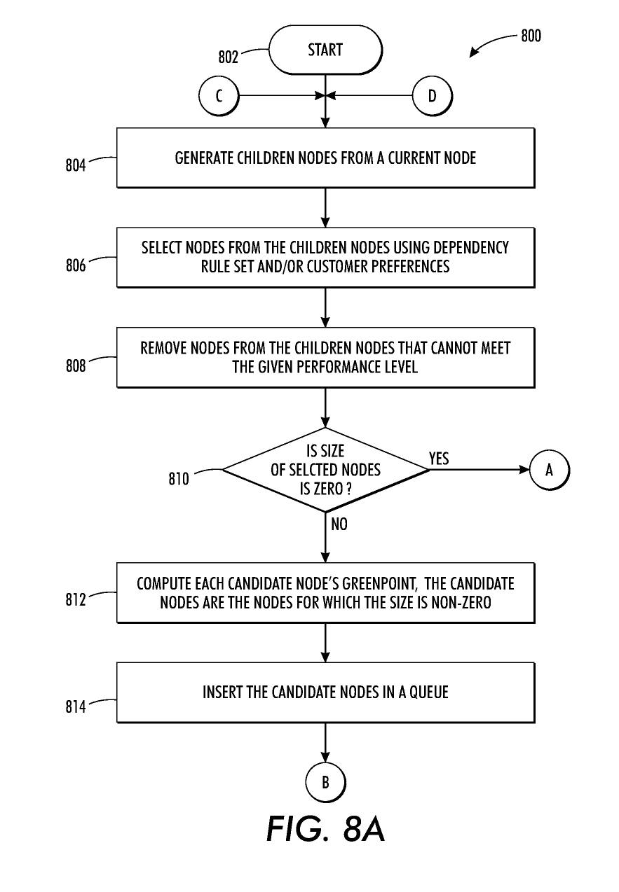

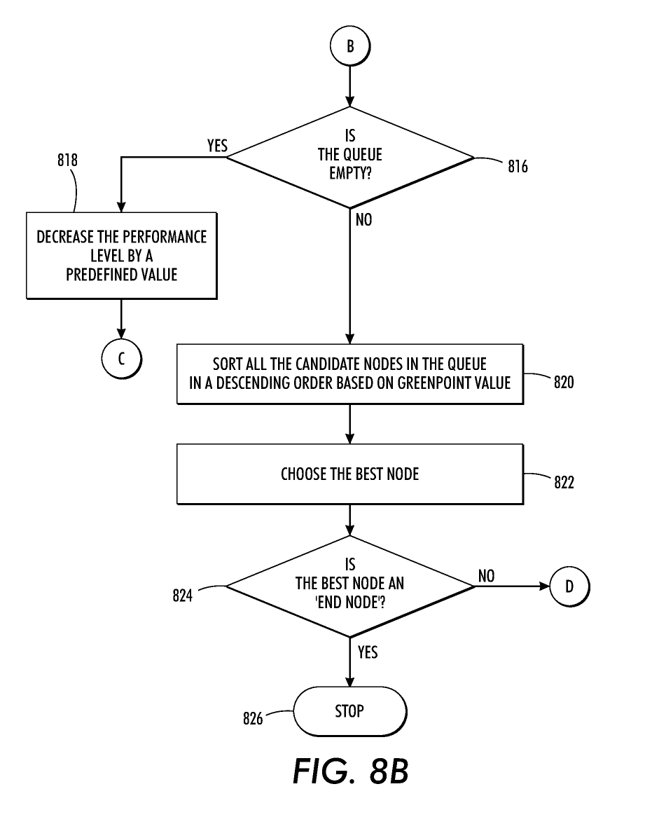

FIGS. 8A-8B is a flowchart illustrating a method 800 of generating a cloud configuration or SLA agreement when the performance level is provided by the customer 110, in accordance with an embodiment of the present disclosure. When the performance level is given the goal of the constraint optimization processor 308 is to search a suitable node by maximizing the Green Point while meeting the performance level. The node refers to one or more resources or services present in the cloud. In one embodiment, the maximal Green Point of a given service application may be computed at each chosen node at each level by the constraint optimization processor 308. This is called the admissible heuristic Green Point value at each node toward an ‘End node’.

At step 802, the search starts based on the given performance level and other dependency constraints. At step 804, children nodes may be generated from a current node. At step 806, one or more nodes are selected from the children nodes using dependency rule set and/or user preference constraints provided by the customer 110. For example, the customer can prefer ‘Dallas’ location as shown in FIG. 7. At step 808, the nodes that do not meet the given performance level are removed from the children nodes.

At step 810, the size of the selected children nodes is checked whether it's ‘zero’. The size of each of the selected nodes can be zero when none of the nodes is meeting the given performance level. If the size of the selected nodes is zero the control goes to step 818, otherwise step 812 is executed. At step 812, the constraint optimization processor 308 may compute the Green Point value of each of the candidates nodes. The candidate nodes are one or more nodes of the selected nodes for which the size is non-zero.

At step 814, the candidate nodes are inserted in a queue. At step 816, the queue is checked whether it is empty. When the size of the candidate nodes is zero then the queue will be empty.

This means that the constraint optimization processor 308 failed to search for node(s) having a given performance level. If the queue is empty then step 818 is executed, otherwise control goes to step 820. At step 818, the performance level is decreased by a predefined value. Then after step 818 control goes to step 804 and steps 804 to 816 are repeated with the lower performance level.

At step 820, the candidate nodes of the queue are arranged in descending order based on their Green Point values. Then at step 822, a best node having the maximal Green Point value is selected from the queue. The best node may become a next starting point of the search. At step 824, the nodes are checked whether the best node is the ‘End node’. If the best node is the ‘End node’ the search ends at step 824, otherwise the control goes to the step 804. The steps 804 onwards are repeated until a node having a maximum Green Point value and the given performance level is found. Thereafter, at step 826, the search stops.

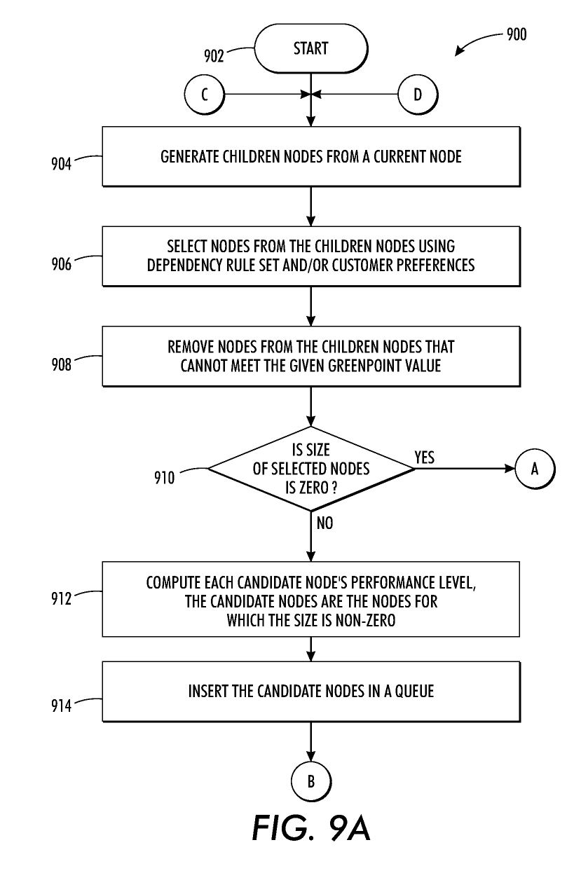

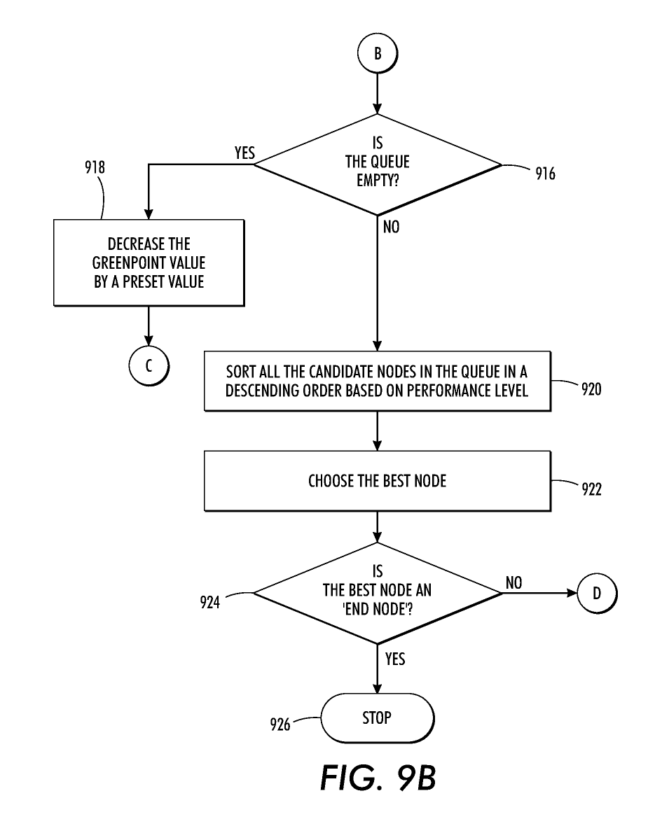

FIGS. 9A-9B is a flowchart illustrating a method 900 of generating a cloud configuration or SLA agreement when the Green Point value is provided by the customer 110, in accordance with an embodiment of the present disclosure. As discussed with reference to FIGS. 3, 4, and 5, when the Green Point value is given the goal of the constraint optimization processor 308 is to search a suitable node by maximizing the performance level while meeting the Green Point value. Herein, the node refers to one or more resources or services present in the cloud. In one embodiment, the maximal performance level of a given service application may be computed at each chosen node at each level by the constraint optimization processor 308. This is called the admissible heuristic performance level at each node toward an ‘End node’.

At step 902, the search starts based on the given Green Point value and other dependency constraints provided by the customer 110. At step 904, children nodes may be generated from a current node. At step 906, one or more nodes are selected from the children nodes using dependency rule set and/or preference constraints provided by the customer 110. For example, the customer 110 can prefer the ‘Dallas’ location as shown in FIG. 6. At step 908, the nodes that do not potentially meet the given Green Point value are removed from the children nodes. This means that if a node's best Green Point does not meet the given Green Point, then that node is removed. This may happen if most of the resources are consumed and few resources are available for the service application.

At step 910, the size of the selected children nodes is checked whether it is ‘zero’. The size of a node refers to the children nodes of the node that satisfy the given criteria. The given criteria may be the high-level parameters or details which are provided or selected by the customer 110. Examples of the high-level parameters include, but are not limited to, Green Point, performance level, budget, location, and so forth. The size of each of the selected nodes can be zero when none of the nodes is meeting the given Green Point criterion. If the size of the selected nodes is zero then the control goes to steps 918, otherwise step 912 is executed. At step 912, the constraint optimization processor 308 computes the performance level of each candidate node. The candidate nodes are one or more nodes of the selected nodes for which the size is non-zero.

At step 914, the candidate nodes are inserted in a queue. At step 916, the queue is checked whether it is empty. If the size of the candidate nodes is zero the queue will be empty. This means the constraint optimization processor 308 failed to locate nodes having the given Green Point value. If the queue is empty step 918 is executed, otherwise control goes to step 920. At step 918, the Green Point value is decreased by a preset value. After step 918 the process control goes to step 904 and steps 904 to 916 are repeated with the lower performance level.

At step 920, the candidate nodes of the queue are arranged in descending order based on their performance level. At step 922 a best node having the maximal Green Point value is selected from the queue. The best node may become the next starting point of the search. At step 924, the best nodes are checked to see whether it is the ‘End node’. If the best node is the ‘End node’ then the search ends at step 924, otherwise the control goes to step 904. The steps 904 onwards are repeated until a node having a maximum Green Point value and the given performance level is found. Thereafter, at step 926, the search stops.

It will be understood that the modules and the databases referred to in the previous sections are not necessarily utilized together in a single form processing system. Rather, these modules are merely exemplary of the various modules that may be implemented within a cloud configuration system. Further, it will be understood that the cloud configuration system may include more modules than the ones described in this disclosure without departing from the scope of the present disclosure.

It will be appreciated that several of the above-disclosed and other features and functions, or alternatives thereof, may be desirably combined into many other different systems or applications. Various presently unforeseen or unanticipated alternatives, modifications, variations, or improvements therein may subsequently be made by those skilled in the art, which are also intended to be encompassed by the following claims.

What is claimed is:

1. A method for providing one or more cloud services to a plurality of customers in a computing cloud, the method comprising:
receiving one or more high-level parameters from a customer through a service requisition interface;
generating the cloud configuration along with a Service Level Agreement (SLA) based on the received high-level parameters;
recommending the generated cloud configuration along with the SLA to the customer through an output interface;
allowing the customer to negotiate terms of the SLA through the service requisition interface based on tradeoff regarding the one or more high-level parameters at a service layer of the cloud through an SLA negotiation system; and
providing the one or more cloud services based on the negotiated SLA to the customer.

2. The method of claim 1, wherein allowing the customer to negotiate the terms of the SLA which further comprises performing the steps of receiving, generating and recommending until the customer is satisfied with the SLA.

3. The method of claim 2 further comprising changing the terms of the SLA based on the service level SLA negotiation.

4. The method of claim 1, wherein the customer selects the high-level parameters from a value set associated with one or more high-level parameter fields of the service requisition interface.

5. The method of claim 1 further comprising receiving one or more service inputs from the customer, wherein the service inputs comprise at least one of a service name and one or more service specific parameters.

6. The method of claim 5, wherein the cloud configuration along with the SLA is generated based on a demand of the customer for service delivery, availability and dependency of hardware and software in the cloud.

7. The method of claim 6, wherein the cloud configuration along with the SLA is generated by using a constraint optimization method based on a best-first graph search method.

8. The method of claim 7, wherein the best-first graph search method is an A* search algorithm.

9. The method of claim 8, wherein the constraint optimization method uses the hardware and software availability and dependency along with the service inputs on high-level parameters as constraints to plan the cloud configuration.

10. The method of claim 1, wherein the high-level parameters include at least one of but not limited to a performance level, Green Point, budget, and location.

11. The method of claim 1, wherein allowing to negotiate the terms of the SLA further comprises at least one of deploying or cancelling terms of the SLA by the customer by selecting one or more buttons of the output interface.

12. The method of claim 1, wherein generating the cloud configuration along with the SLA further comprises estimating at least one of a budget, a Green Point, a performance level, and energy consumption for each possible cloud configuration based on the received high-level parameters.

13. A method for providing cloud based services to a customer in a cloud, the method comprising:
receiving one or more high-level parameters from the customer through a service requisition interface, wherein the high-level parameters include at least one of a performance level, Green Point, budget, and location;
generating a cloud configuration along with a Service Level Agreement (SLA) based on the received high-level parameters, wherein the cloud configuration along with the SLA is generated by using a constraint optimization method based on a best-first graph search method;
recommending the generated cloud configuration along with the SLA to the customer through an output interface;
allowing the customer to negotiate the SLA through the service requisition interface based on a tradeoff regarding the one or more high level details at a service layer of the cloud, wherein allowing the customer to negotiate the SLA further comprises performing the steps of receiving, generating and recommending until the customer is satisfied with the SLA; and
providing the one or more cloud services based on the negotiated SLA to the customer.

14. The method of claim 13, wherein the customer selects the high-level parameters from a value set associated with one or more high-level parameter fields of the service requisition interface.

15. The method of claim 13 further comprising receiving one or more service inputs from the customer, wherein the service inputs comprise at least one of a service name and one or more service specific parameters.

16. The method of claim 15, wherein the cloud configuration along with the SLA is generated based on a demand of the customer for service delivery, availability and dependency of hardware and software in the cloud.

17. The method of claim 16, wherein the best-first graph search method is an A* search algorithm.

18. The method of claim 17, wherein the constraint optimization method uses the hardware and software availability and dependency along with the service inputs on high-level parameters as constraints to plan the cloud configuration.

19. The method of claim 13, wherein allowing the customer to negotiate the SLA further comprises at least one of deploying or cancelling the SLA by the customer by selecting one or more buttons of the output interface.

20. The method of claim 13, wherein generating the cloud configuration along with the SLA further comprises estimating at least one of a budget, a Green Point, a performance level, and energy consumption for each possible cloud configuration based on the received high-level parameters.

21. A system for providing one or more cloud services to a plurality of customers in a cloud, the system comprising:
a cloud configuration system at a service layer of the cloud, the cloud configuration system comprising:
a service requisition interface for receiving one or more high-level parameters from a customer, wherein the service requisition interface includes one or more high-level parameter fields;
a cloud configuration generator for generating the cloud configuration along with a Service Level Agreement (SLA) based on the received high-level parameters;
an output interface for recommending the generated cloud configuration along with the SLA to the customer; and
an SLA negotiation system for allowing the customer to negotiate the SLA through the service requisition interface based on tradeoffs regarding the one or more high level details at a service layer of the cloud;
wherein the cloud provides the one or more cloud services based on the negotiated SLA to the customer.

22. The system of claim 21, wherein the SLA negotiation system is further configured to change the SLA based on the service level negotiation.

23. The system of claim 21, wherein the customer selects the high-level parameters from a value set associated with one or more high-level parameter fields of the service requisition interface.

24. The system of claim 21, wherein the service requisition interface is further configured to receive one or more service inputs from the customer, wherein the service inputs comprise at least one of a service name and one or more service specific parameters.

25. The system of claim 24, wherein the cloud configuration generator generates the cloud configuration along with the SLA based on a demand of the customer for service delivery, availability and dependency of hardware and software in the cloud.

26. The system of claim 25, wherein the cloud configuration generator further comprises a constraint optimization processor for searching resources based on the received service inputs and high-level parameters while considering software and hardware availabilities and their dependency.

27. The system of claim 26, wherein the constraint optimization processor searches for the resources by using a constraint optimization method based on a best-first graph search method, and wherein the constraint optimization method uses the hardware and software availability and dependency along with the service inputs on high-level parameters as constraints to plan the cloud configuration.

28. The system of claim 27, wherein the best-first graph search method is an A* search algorithm.

29. The system of claim 21, wherein the high-level parameters include at least one of a performance level, Green Point, budget, and location.

30. The system of claim 21, wherein the one or more buttons of the output interface include at least one of a deploy button and a cancel button, wherein the customer can initiate a negotiation of the SLA by selecting the cancel button.

31. The system of claim 21, wherein the cloud configuration generator is further configured to estimate at least one of a budget, a Green Point, a performance level, and energy consumption for each possible cloud configuration based on the received high-level parameters.

32. The system of claim 21, wherein the cloud further comprises a middleware layer and an infrastructure layer.
